(19) United States
(12) Patent Application Publication
(10) Pub. No.: US 2006/0222759 A1
(43) Pub. Date: Oct. 5, 2006

(54) Plastic film and manufacturing method thereof

(75) Inventors: Tatsuya Nomura, Shizuoka-ken (JP); Shinji Tanaka, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/358,284

(22) Filed: Feb. 22, 2006

(30) Foreign Application Priority Data
Mar. 31, 2005 (JP) 2005-105147

(51) Int. Cl. B05D 5/06

(52) U.S. Cl. 427/66

(57) ABSTRACT

The present invention provides a method of manufacturing a film, the method including coating with a liquid containing a polyvinyl alcohol having a saponification degree of 96 mol % or more on at least one surface of a plastic film support, and drying the coated liquid at a temperature of from 165 to 230° C. to form a protective layer.

### CROSS-REFERENCE TO RELATED APPLICATION

This application claims priority under 35 USC 119 from Japanese Patent Application No. 2005-105147, the disclosure of which is incorporated by reference herein.

### BACKGROUND OF THE INVENTION

1. Field of the Invention

The present invention relates to a plastic film and particularly to a film having a protective layer excellent in abrasion resistance.

2. Description of the Related Art

Plastic films widely used in various industrial fields such as electronic industry and printing industry have been used in a wide variety of fields such as general industry, movie, photography, magnetic recording, packaging and vapor deposition owing to their excellent electrical characteristics, mechanical characteristics, chemical resistance, heat resistance, optical characteristics, etc.

However, plastic films generally have a high friction coefficient due to their surface smoothness, and often suffer surface abrasions in spite of their mechanical strength. Further, they tend to be statically charged due to their electric characteristics, and dust adhering thereon often causes the surface abrasions.

In light of these problems, a technique of providing a highly abrasion-resistant coating layer (for example, refer to JP-A Nos. 10-97028 and 2001-310423) and a technique of providing a slippery coating layer (for example, refer to JP-A No. 11-194449 and JP-A No. 2000-194091) have been disclosed for improving the abrasion resistance on the surface of plastic films.

For an antistatic film, a technique of providing a coating layer containing an organic conductive compound or an inorganic metal oxide has been known for a long time.

Generally, use of the inorganic metal oxide as a conductive agent can provide less humidity dependency and thus excellent antistatic property can be obtained, but this can not improve the drawback of low abrasion resistance. It is important to improve both the antistatic property and the abrasion resistance for improving the abrasion resistance of plastic films, for which a technique of providing an overcoat layer on an antistatic coating layer has been disclosed (for example, refer to JP-A Nos. 2001-310423 and 11-194449).

JP-A No. 7-330931 discloses a method of providing an antistatic layer on a polyester film after biaxial stretching and then providing thereon a protective layer containing a polyvinyl alcohol with a saponification degree of 96 mol % or more to obtain an antistatic film excellent in blocking property and solvent resistance.

However, when using the film being exposed to water (wet state), there is a problem that the protective layer is somewhat eluted. Accordingly, polyvinyl alcohols could not be used for the back surface protective layer of a silver halide photosensitive material to be subjected to wet type development processing.

Further, JP-A No. 8-36239 reports the use of a polyolefin material on a conductive layer containing an inorganic metal oxide for the back surface of a silver halide photosensitive material.

However, while the polyolefin material shows excellent water resistance and abrasion resistance, when used as a back surface protective layer of a silver halide photosensitive material, there is a problem of static electricity easily generated due to the difference of the triboelectric series relative to gelatin which is a main binder used for the protective layer at the photosensitive layer side.

For an antistatic film using a polyvinyl alcohol, a method of coating a polyester film support with a coating liquid containing an antistatic agent and a partially saponified polyvinyl alcohol resin to prevent deterioration of the antistatic performance of the film and whitening of the film has been disclosed (for example, JP-A No. 5-116216).

However, although it is dried at a high temperature of 230° C., because of the use of the partially saponified polyvinyl alcohol, there is thought to be a problem of the abrasion resistance of the outermost layer, particularly, a problem of abrasions caused by elution of the coating when using the film being exposed to water (wet state). Further, since pre-coating method of providing the coating layer before stretching is used, it is difficult to recover lug portions in the stretching step after the coating step, tending to lower the productivity.

### SUMMARY OF THE INVENTION

The present invention has been made in view of the above circumstances and provides a method of manufacturing a film excellent in solvent resistance, water resistance, abrasion resistance and blocking property, and a film manufactured by using the method. That is, the invention provides a method of manufacturing a film, the method comprising coating with a liquid containing a polyvinyl alcohol having a saponification degree of 96 mol % or more on at least one surface of a plastic film support, and drying the coated liquid at a temperature of from 165 to 230° C. to form a protective layer, and a film manufactured by using the method.

### BRIEF DESCRIPTION OF THE DRAWINGS

FIG. 1 is a cross sectional view showing a silver halide photographic photosensitive material formed by using a film of Example 4.

### DETAILED DESCRIPTION OF THE INVENTION

A method of manufacturing a film according to the invention comprises coating with a liquid containing a polyvinyl alcohol having a saponification degree of 96 mol % or more on at least one surface of a plastic film support, and drying the coated liquid at a temperature of from 165 to 230° C. to form a protective layer.

Since the film of the invention is manufactured by the manufacturing method comprising drying by heating at high temperature, crystallization of the polyvinyl alcohol is promoted, and excellent water resistance, abrasion resistance in the wet state, and blocking property can be attained in addition to the solvent resistance.

Hereinafter, the film of the invention and the manufacturing method thereof are described in detail, but the invention is not restricted to such descriptions and exemplified compounds.

(Formation of Protective Layer)

The protective layer in the invention is provided by coating with a protective layer coating liquid on at least one surface of a plastic film support. The protective layer coating liquid contains a polyvinyl alcohol having a saponification degree of 96 mol % or more.

The polyvinyl alcohol used in the invention is obtained by hydrolyzing polyvinyl acetate and satisfies the saponification degree (value determined in accordance with JIS K 6726) of 96 mol % or more.

The polyvinyl alcohol is preferably represented by the following formula (I). By the use of such a polyvinyl alcohol, the hydrophobic property on the surface can be further enhanced, and the water resistance, the abrasion resistance and the blocking property can be further improved.

This is thought to be because the hydrophobic group at the terminal R in the following formula (I) is oriented to the surface of the coating film when coating with the protective layer coating liquid.

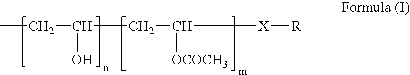

In the formula (I), R represents a saturated or unsaturated hydrocarbon group having 5 to 30 carbon atoms. Number of the carbon atoms is preferably from 7 to 20, and particularly preferably from 10 to 14. Examples of the saturated or unsaturated hydrocarbon group include alkyl groups (for example, pentyl, hexyl, heptyl, octyl, nonyl, decyl, undecyl, dodecy, tridecyl, tetradecyl, pentadecyl, hexadecyl, and heptadecyl groups), and aryl groups (having preferably from 6 to 20 carbon atoms, and particularly preferably from 10 to 14 carbon atoms, such as butylphenyl, pentylphenyl, hexylphenyl, heptylphenyl and octylphenyl groups).

In the formula (I), X represents S or O, S being preferred. In the formula (I), n represents the polymerization degree of vinyl alcohol groups, and m represents the polymerization degree of vinyl acetate groups.

The polymerization degree (n+m) of the polyvinyl alcohol is preferably from 100 to 10,000, and more preferably from 200 to 5,000. Hydrogen is usually bonded to the left terminal of the polyvinyl alcohol to form a methyl group.

As the polyvinyl alcohol represented by the formula (I), commercial products (for example, 5% aqueous solution of MP 103 (manufactured by Kuraray Co., saponification degree of 98.5 mol %, polymerization degree of 300: refer to followings), or 5% aqueous solution of MP102 (manufactured by Kuraray Co., saponification degree of 98.5 mol %, polymerization degree of 200: refer to followings)) can be used, or those synthesized by introducing ether groups or thiol groups by radical reaction using a known method can also be used, without any limitation.

For improving the water resistance of the polyvinyl alcohol, various known crosslinkers may also be used together. Examples of the crosslinker include epoxy compounds or resins, melamine resins, silane coupling agents, various kinds of metal compounds and urea resins, etc.

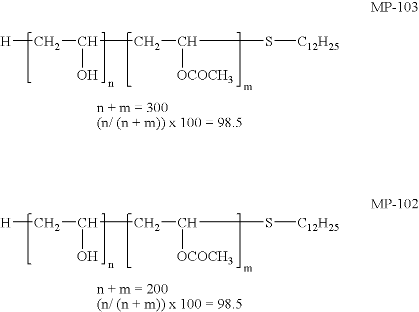

The content of the polyvinyl alcohol in the total solid of the protective layer coating liquid is not particularly limited, and from the viewpoint of the abrasion resistance, from 30 to 100 mass % is preferred, from 40 to 90 mass % is more preferred, and from 50 to 80 mass % is particularly preferred.

In the preparation of the protective layer coating liquid, a surfactant and a matting agent (fine organic particles, fine inorganic particles, a mixture thereof, etc.) may optionally be added to a solvent in addition to the above-describe additives. As the solvent, water, organic solvents, etc. can be used.

The protective layer coating liquid can be prepared by adding the polyvinyl alcohol having a saponification degree of 96 mol % or more to a solvent.

The protective layer can be formed by coating with the protective layer coating liquid, for example, a liquid (for example, aqueous solution, aqueous dispersion, suspension, and emulsion) containing the polyvinyl alcohol (optionally a surfactant, matting agent or plasticizer, and crosslinker are added thereto) on a plastic film support, or on another layer in the case of forming another layer on the support, and then drying the coated liquid by heating at 165 to 230° C. for 0.1 to 10 min.

The temperature for the drying by heating have to be from 165 to 230° C., and is preferably not lower than the glass transition point (Tg) but not higher than the melting point of the polyvinyl alcohol, more preferably 170 to 200° C., and particularly preferably from 175 to 195° C.

Within the above-described range of the temperature for the drying by heating, crystallization of the polyvinyl alcohol can be favorably promoted to attain excellent water resistance, abrasion resistance in wet state and blocking property in addition to the solvent resistance.

The heating time depends on the drying temperature and is generally from 0.1 to 10 min, preferably from 0.5 to 5 min from the viewpoint of improving the productivity, and more preferably from 0.5 to 2 min.

Coating with the liquid is not particularly limited and can be conducted by a known coating method, for example, dip coating method, air knife coating method, curtain coating method, roller coating method, wire bar coating method, gravure coating method or extrusion method using a hopper. Further, simultaneous coating of two or more layers (for example, antistatic layer and protective layer) may also be conducted by utilizing the methods described in U.S. Pat. Nos. 2,761,791, 3,508,974, 2,941,898, and 3,508,947, as well as in “Coating Technology” (written by Ozaki, et al., p 253, published from Asakura Shoten in 1973).

The thickness of the protective layer is preferably within a range from 0.01 to 10 μm, and particularly preferably within a range from 0.05 to 2.0 μm. In the case where the thickness is less than 0.01 μm, the layer sometimes has no abrasion resistance function as the protective film. On the other hand, in the case where the thickness is more than 10 μm, the layer needs a longer drying time for promoting crystallization of PVA to sometimes lower the productivity.

(Formation of Antistatic Layer)

The film of the invention is preferably provided with an antistatic layer since it is manufactured by using a plastic support. By the provision of the antistatic layer, deposition of dust or dirt on the film surface can be prevented.

The antistatic layer may be a layer comprising an antistatic agent such as a surfactant and a binder, a layer in which a conductive metal oxide is dispersed in a binder, or a layer comprising a conductive polymer. In the invention, a layer in which a conductive metal oxide is dispersed in the binder is preferred since the antistatic property at low humidity is excellent. Examples of the conductive metal oxide include ZnO, TiO₂, SnO₂, Al₂O₃, InO₃, SiO2, MgO, BaO, and MoO₃. Composite oxides of them may also be included. As the conductive metal oxide, ZnO, TiO₂, and SnO₂ are preferred. Further, the composite oxides preferably contain different kind of elements, such as Al or In with respect to ZnO, Nb or Ta with respect to TiO₂, and Sb, Nb or halogen elements with respect to SnO₂, in an amount of from 0.01 to 30 mol % (particularly preferably from 0.1 to 10 mol %). Further, a core-shell type powder formed by coating with such a conductive metal oxide on the surface may also be used. The intrinsic volume resistivity of the conductive metal oxide is preferably from 10 to 10⁷ Ω·cm, and particularly preferably from 10³ to 10⁵ Ω·cm. Further, those having an oxygen defect in the crystal of the metal oxide and those containing a small amount of a different kind of element as a so-called donor with respect to the metal oxide are preferred since the conductivity is increased. The particle size of the conductive metal oxide is preferably 0.5 μm or less, and more preferably 0.2 μm or less.

Examples of the resins usable as the binder in the antistatic layer include proteins such as gelatin, gelatin derivatives, colloidal albumin and casein; cellulose compounds such as hydroxyethyl cellulose (HEC); carboxymethyl cellulose (CMC), diacetyl cellulose and triacetyl cellulose; saccharide derivatives such as agar, sodium alginate and starch derivatives; water soluble resins such as polyvinyl alcohol (PVA), poly-N-vinyl pyrrolidone (PVP), poly(meth)acrylic acid, copolymers containing (meth)acrylic acid and polyacrylamide, or derivatives thereof or partial hydrolyzates thereof; polyvinyl acetate, polyacrylonitrile, polyacrylate esters, copolymers containing (meth)acrylate esters, vinyl acetate-(meth)acrylate copolymers, styrene-butadiene copolymers, polyolefins, vinyl polymers or copolymers such as olefin-vinylacetate copolymers; natural resins such as rosin and shellac and derivatives thereof; and organic semiconductors such as polypyrole. Such resins may be used in any form such as a solution or latex.

The antistatic layer can be formed, for example, by coating with a coating liquid or liquid suspension (optionally with addition of water, organic solvent, etc.) containing the conductive metal oxide and the binder on a plastic film support and drying the coated liquid by heating. Coating with the liquid can be conducted by a known coating method, for example, dip coating method, air knife coating method, curtain coating method, roller coating method, wire bar coating method, gravure coating method or extrusion method using a hopper. Further, simultaneous coating of two or more layers (for example, antistatic layer and protective layer) may also be conducted by utilizing the methods described in U.S. Pat. Nos. 2,761,791, 3,508,974, 2,941,898, and 3,508,947, as well as in “Coating Technology” (written by Ozaki, et al., p 253, published from Asakura Shoten in 1973).

In the case of using the conductive metal oxide described above as the antistatic agent, in order to increase the transmittance of the antistatic layer and for preventing the light scattering from increasing due to increase in the difference of the refractive index between the metal oxide and the binder, it is preferred to control the refractive index for each of them to an identical extent. The control can be conducted by controlling the particle size of the metal oxide. Since the refractive index of the binder is within a range from 1.4 to 1.6, the diameter of the particles of the conductive metal oxide is preferably 0.5 μm or less, and particularly preferably 0.2 μm or less. By the use of the metal oxide of 0.2 μm or less, the light scattering efficiency can be 10% or less.

The volume resistivity of the antistatic layer is generally from 10¹ to 10¹⁰ Ω·cm (preferably from 10¹ to 10⁹ Ω·cm, and more preferably from 10¹ to 10⁸ Ω·cm) and such resistivity can be obtained by controlling the volume content of the conductive metal oxide in the layer and controlling the thickness of the antistatic layer.

The thickness of the antistatic layer is preferably within a range from 0.01 to 10 μm, and particularly preferably within a range from 0.05 to 2.0 μm.

(Plastic Film Support)

Examples of a material for the plastic film which can be used as the plastic film support include polyesters such as polyethylene phthalate, and polyethylene naphthalate; cellulose esters such as nitrocellulose, cellulose triacetate and cellulose acetate butylate, and further, polycarbonate, polystyrene, polyethylene and polypropylene. Among them, polyethylene phthalate, polycarbonate, and polyethylene are preferred, and polyethylene phthalate is particularly preferred.

The plastic film is preferably a monoaxially stretched or biaxially stretched plastic film, and the biaxially stretched plastic film is preferred from the view point of mechanical strength.

The thickness of the plastic film is not particularly limited and is generally within a range from 15 to 500 μm, preferably from 50 to 200 μm, and particularly preferably from 40 to 200 μm in view of easy handling and general-purpose use.

Further, the plastic film support may be transparent and may contain a dye, dye-type silicon, alumina sol, chromium salt, or zirconium salt.

Further, the plastic film supports subjected to corona discharge treatment, flame treatment or UV-ray irradiation treatment may be used. They may further contain a UV-absorbent or heat absorbent.

The following surface treatments are applied particularly for strongly bonding the photosensitive layer (described later) to the surface of the plastic film support. Similar surface treatments are generally applied to the surface at the side where the antistatic layer is formed.

There are two methods: (1) a method of obtaining adhesion strength by applying a surface treatment such as chemical treatment, mechanical treatment, corona discharge treatment, flame treatment, UV ray treatment, high frequency wave treatment, glow discharge treatment, active plasma treatment, laser treatment, mixed acid treatment, or ozone oxidation treatment, and then directly coating with a photographic emulsion (photosensitive layer-forming coating liquid); and (2) a method of once conducting the surface treatment described above, providing an undercoat layer, and then coating with a photographic emulsion thereon.

Among them, the method (2) is more effective and has been conducted generally. It is thought that the effectiveness is as follows. By the surface treatment described above, polar groups are formed to some extent on the surface of the support which is hydrophobic by nature, a thin film which gives an adverse factor with respect to the surface adhesion is removed, or the cross-linking density on the surface is increased, which enhances the adhesion. As a result, the adhesion strength between the undercoat layer and the support surface is improved by the increase of the affinity with the polar groups of the ingredients contained in the solution for the undercoat layer, or by the increase of the fastness on the bonded surface.

The method of coating with the undercoat layer may be, for example, a so-called double layer method of forming a layer which bonds to the support satisfactorily as a first layer and then coating with a gelatin layer thereon as a second layer, and a single layer method of coating with only one layer of a resin containing both of a hydrophobic group and a hydrophilic group.

The method of forming the undercoat layer may be, for example, a method of forming, in an aqueous system, two undercoat layers composed of a first undercoat layer of a polymer material and a second undercoat layer of gelatin.

The polymer material of the first undercoat layer may be, for example, a copolymer containing, as a starting material, a monomer selected from the group consisting of vinyl chloride, vinylidene chloride, butadiene, methacrylic acid, acrylic acid, itaconic acid, and maleic acid anhydride, as well as polyethylene imine, epoxy resin grafted gelatin, and nitrocellulose. A hardener such as a dichlorotriazine derivative, epoxy compound, carbodiimide compound, or oxazoline compound is generally used for the formation of the first undercoat layer and the second undercoat layer of gelatin.

To the first undercoat layer, phenol or resorcin, for example, may optionally be added as a swelling agent, and the addition amount is from 1 to 10 g per one liter of the first undercoat layer coating liquid. A hydrophilic polymer may be used for the first undercoat layer and examples of the polymer include a natural polymer such as gelatin, or a synthetic polymer such as polyvinyl alcohol, vinyl acetate-maleic acid anhydride copolymer, acrylic acid-acrylamide copolymer, or styrene-maleic acid anhydride copolymer. Further, as a blocking inhibitor, a matting agent (silicon dioxide, polymethyl acrylate and polystyrene) or methyl cellulose, polyvinyl alcohol, etc. can be used.

Coating with the first undercoat layer coating liquid according to the invention can be conducted by a well-known coating method such as dip coating method, air knife coating method, curtain coating method, roller coating method, wire bar coating method, gravure coating method, or an extrusion coating method using a hopper described in U.S. Pat. No. 2,681,294. In the case where a second undercoat layer is further formed on the undercoat layer, simultaneous coating of two or more layers may be conducted by the methods described in U.S. Pat. Nos. 2,761,791, 3,508,947, 2,941,898, and 3526528, as well as in “Coating Technology” (written by Ozaki, et al., p 253, published from Asakura Shoten in 1973) as required.

The coating amount of the first undercoat layer and that of the second undercoat layer to be formed on the first undercoat layer according to the invention are, as a solid content, preferably from 0.01 to 10 g, and particularly preferably from 0.2 to 3 g per one m² of the plastic film support. In the invention, the second undercoat layer is not particularly limited and, for example, a hydrophilic colloidal layer containing gelatin as a main component can be formed.

Examples of the hydrophilic polymer to be used for the second undercoat layer other than gelatin include synthetic or natural hydrophilic polymer compounds, for example, acylated gelatin such as phthalated gelatin and maleic gelatin, cellulose derivatives such as carboxymethyl cellulose and hydroxyethyl cellulose, grafted gelatin in which acrylic acid, methacrylic acid or amide is grafted on gelatin, polyvinyl alcohol, polyhydroxyalkyl acrylate, polyvinyl pyrrolidone, vinyl pyrrolidone/vinyl acetate copolymer, casein, agarose, albumin, sodium alginate, polysaccharide, agar, starch, grafted starch, polyacrylamide, polyethyleneimine acyl compounds, and homopolymers or copolymers of acrylamide acryl ate or methacrylate, N-substituted acrylamide, N-substituted methacrylamide, etc. and partial hydrolyzates thereof. They may be used alone or as a mixture thereof.

To the hydrophilic polymer described above, a known antistatic agent, crosslinker, matting agent, or antiblocking agent can optionally be added.

Also, the film obtained by the manufacturing method of the invention is preferably a film in which the protective layer is formed on one surface of the plastic film support and a photosensitive silver halide photographic emulsion layer (hereinafter sometimes referred to as “photosensitive layer”) is formed on the other surface of the plastic film support.

(Formation of a Photosensitive Silver Halide Photographic Emulsion Layer)

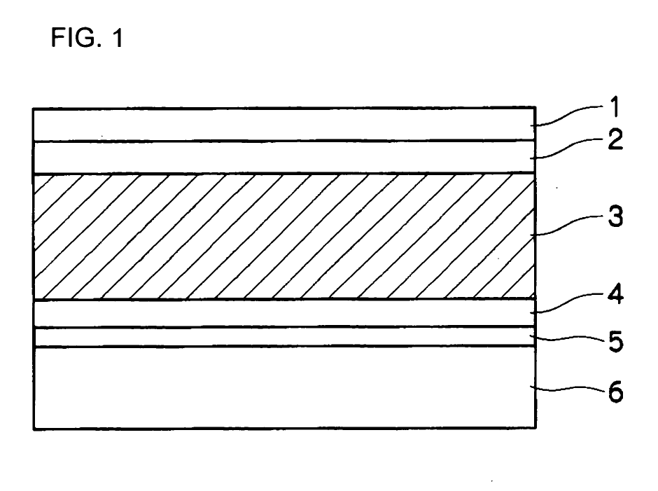

FIG. 1 is a cross-sectional view showing an example of a silver halide photosensitive material having the photosensitive silver halide photographic emulsion layer (photosensitive layer) of the invention.

The silver halide photosensitive material shown in FIG. 1 can be produced, for example, by the following.

First, an antistatic layer coating liquid is coated on one surface of a polyester film 3 and dried to form an antistatic layer 2. Then, a protective layer coating liquid containing a polyvinyl alcohol having a saponification degree of 96 mol % or more is coated on the antistatic layer 2 (for example, by bar coating method) to form a protective layer 1. On the other surface of the polyester film 3, the first undercoat layer coating liquid (containing, for example, adhesive SBR) of the polymer material and the second undercoat layer coating liquid (containing, for example, gelatin), which are described in the paragraph for the plastic film support, are coated to form two undercoat layers 4 and 5. Successively, the photosensitive silver halide emulsion described later is coated thereon to form a photosensitive layer 6, thereby obtaining a silver halide photosensitive material.

The emulsion for forming the photosensitive layer may be, for example, a photosensitive silver halide photographic emulsion used for known silver halide photographic photosensitive materials.

Examples of the binder (hydrophilic organic protective colloid) for the emulsion for forming the photosensitive layer include synthetic or natural hydrophilic polymer compounds, for example, gelatin, acylated gelatin such as phthalized gelatin and maleic gelatin, cellulose derivatives such as carboxymethyl cellulose and hydroxyethyl cellulose, grafted gelatin in which acrylic acid, methacrylic acid or amide (acrylamide or the like) is grafted on gelatin, polyvinyl alcohol, polyhydroxyalkyl acrylate, polyvinyl pyrrolidone, vinyl pyrrolidone/vinyl acetate copolymer, casein, agarose, albumin, sodium alginate, polysaccharide, agar, starch, grafted starch, polyacrylamide, polyethyleneimine acylated compounds, and partial hydrolyzates thereof. They may be used alone or as a mixture thereof.

As long as the binder in the emulsion for forming the photosensitive layer is the hydrophilic polymer compound as described above, it is not particularly important what is added therein. Usually, in the hydrophilic binder, physical development nuclei such as silver halide or silver sulfide used in diffusion transfer photographic process, or various kinds of additives, for example, photosensitive materials such as diazo compounds, and couplers, emulsion polymerization polymers, latex polymers, etc. are added.

Various materials to be used for the emulsion for forming the photosensitive layer, for example, silver halide particles, chemical sensitizers, dyes, polymer latexes, surfactants, gelatin hardeners, color couplers, fade-preventing agents, antistatic agents, and matting agents are not particularly restricted, and description, for example, in Research Disclosure pp. 22 to 31, Vol. 176 (December, 1978) can be referred to.

In the invention, surface treatment such as corona discharge treatment may be applied not only to the hydrophobic support but also to the first undercoat layer and/or the second undercoat layer although this is not always necessary, and this can improve the adhesion between the layers after the treatment.

The surface resistivity of the film obtained by the manufacturing method of the invention is generally within a range of from 10¹ to 10¹² Ω/□, preferably within a range from 10⁶ to 10¹² Ω/□, and further preferably within a range from 10⁹ to 10¹² Ω/□.

Haze showing the transparency of the film obtained by the manufacturing method of the invention is not particularly restricted but it is preferably 2% or less, and particularly preferably 1.5% or less.

### EXAMPLES

Hereinafter, the invention will be described specifically by way of examples, but the invention is not restricted to them. In the invention, “parts” and “%” represent mass parts and mass % respectively, unless otherwise specified.

### Example 1

[Preparation of Antistatic Plastic Film]

(1) Preparation of Support

A polyethylene glycol terephthalate (PET) with an intrinsic viscosity: IV=0.66 was obtained using terephthalic acid and ethylene glycol in accordance with an ordinary method.

After pelletizing the PET, the obtained pellets were subjected to a crystallization step at 110 to 130° C. for one hour and a dehydration step at 180° C. for 3.5 hours, then melted, extruded from a T-die and quenched, to prepare an unstretched film.

The film was subjected to longitudinal stretching by 3.2 times using rolls of different circumferential speeds, then to lateral stretching by 3.3 times by a tenter to obtain a support having a thickness of 120 μm.

(2) Formation of Antistatic Layer

In a state where the support obtained as described above was handled at a velocity of 100 m/min, a corona discharge treatment were applied to both surfaces of the support under the condition of 727 J/m², and a coating liquid A having the composition described below was coated thereon by a bar coating method. The coating amount was about 7.1 ml/m², and the coated liquid was dried at 185° C. for one min.

<Composition of coating liquid A for antistatic layer>

| | |
|---|---|
| Polyacrylic resin | 19 parts |
| (Solid concentration: 30%, Julimer ET-410, | |
| manufactured by Takamatsu Oil & Fat Co., Ltd.) | |
| Aqueous dispersion of tin oxide-antimony oxide | 91 parts |
| (Solid concentration: 17%, R533D, manufactured | |
| by Mitsubishi Material Corp. average secondary | |
| particle size: 0.1 μm) | |
| Carbodiimide resin | 4.5 parts |
| (Solid concentration: 40%, Carbodilite V02-L2, | |
| manufactured by Nisshinbo Industries, Inc.) | |
| Sodium diphenyl ether sulfonate | 1.4 parts |
| (Solid concentration: 44.5%, Sundet BL, manufactured | |
| by Sanyo Chemical Industries Co. Ltd.) | |
| Polyoxyethylene surfactant | 12.4 parts |
| (5% aqueous solution of Naroacty NH-100 | |
| (manufactured by Sanyo Chemical Industries, Co. Ltd.) | |
| Distilled water | 871.7 parts |

(3) Formation of Protective Layer, and Preparation of Antistatic Plastic Film

Subsequently, a protective layer was formed on the coated layer (antistatic layer) by coating with a coating liquid B having the composition described below by a bar coating method. The coating amount was about 7.1 ml/m², and the drying condition was as described in Table 1.

Thus, an antistatic plastic film was obtained.

<Composition of coating liquid B for protective layer>

| | |
|---|---|
| Aqueous solution of polyvinyl alcohol resin | 300 parts |
| (5% aqueous solution of PVA 105 (saponification | |
| degree: 98.5 mol %, polymerization | |
| degree: 500, manufactured by Kuraray Co., Ltd.) | |
| Polyoxyethylene surfactant | 8 parts |
| (5% aqueous solution of Naroacty NH-100 | |
| (manufactured by Sanyo Chemical Industries, Co. Ltd.) | |
| Distilled water | 692 parts |

### Example 2

An antistatic plastic film was obtained in the same manner as in Example 1 except for using the coating liquid C for a protective layer described below instead of the coating liquid B for the protective layer in Example 1.

Composition of coating liquid C for the protective layer

| | |
|---|---|
| Aqueous solution of polyvinyl alcohol resin | 300 parts |
| (5% aqueous solution of PVA 105 (saponification degree: | |
| 98.5 mol%, polymerization degree: 500, manufactured by | |
| Kuraray Co., Ltd.)) | |
| Polyoxyethylene surfactant | 8 parts |
| (5% aqueous solution of Naroacty NH-100 (manufactured by | |
| Sanyo Chemical Industries, Co. Ltd.) | |
| Colloidal silica | 30 parts |
| (Snowtex C, solid concentration of 20%, manufactured by | |
| Nissan Chemical Industries Ltd.) | |
| Epoxy resin | 38 parts |
| (4% aqueous solution of Deconal EX 521 (manufactured by | |
| Nagase Chemtex Corp.)) | |
| Fluoro surfactant | 59 parts |
| (0.1% aqueous solution of the compound (1) described below) | |
| Distilled water | 692 parts |
| 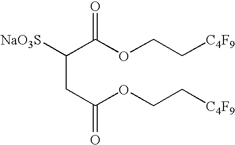 | |

### Example 3

An antistatic plastic film was obtained in the same manner as in Example 2 except for using a coating liquid D for a protective layer in which an aqueous solution of polyvinyl alcohol resin “5% aqueous solution of “PVA 105 (saponification degree: 98.5 mol %, polymerization degree: 500, manufactured by Kuraray Co., Ltd.)” was changed to an aqueous solution of polyvinyl alcohol resin modified at terminal alkyl group “5% aqueous solution of MP 103 (saponification degree: 98.5 mol %, polymerization degree: 300, manufactured by Kuraray Co., Ltd.)” in <Composition of coating liquid C for protective layer> in Example 2.

### Example 4

An antistatic plastic film was obtained in the same manner as in Example 2 except for using a coating liquid E for a protective layer in which an aqueous solution of polyvinyl alcohol resin “300 parts of 5% aqueous solution of PVA 105 (saponification degree: 98.5 mol %, polymerization degree: 500, manufactured by Kuraray Co., Ltd.)” was changed to an aqueous solution of a polyvinyl alcohol resin “150 parts of 5% aqueous solution of PVA 110 (saponification degree: 98.5 mol %, polymerization degree: 1000, manufactured by Kuraray Co., Ltd.)” and an aqueous solution of polyvinyl alcohol resin modified at terminal alkyl group “150 parts of 5% aqueous solution of MP 103 (saponification degree: 98.5 mol %, polymerization degree: 300, manufactured by Kuraray Co., Ltd.) in <Composition of coating liquid C for protective layer> in Example 2.

By preparing a silver halide photographic photosensitive material using the obtained film excellent in solvent resistance, abrasion resistance and blocking property, the performance of the film of the invention was confirmed.

### Examples 5 and 6

Antistatic plastic films were obtained in the same manner as in Example 2 except for changing the temperatures for drying the protective layer to 195° C. and 165° C. respectively in “Formation of protective layer” in Example 2.

### Comparative Examples 1 and 2

Antistatic plastic films were obtained in the same manner as in Example 2 except for changing the temperatures for drying the protective layer to 155° C. and 135° C. respectively in “Formation of protective layer” in Example 2.

### Comparative Example 3

An antistatic plastic film was obtained in the same manner as in Example 2 except for using a coating liquid F for protective layer in which an aqueous solution of polyvinyl alcohol resin “300 parts of 5% aqueous solution of PVA 105 (saponification degree: 98.5 mol %, polymerization degree: 500, manufactured by Kuraray Co., Ltd.)” was changed to an aqueous solution of polyvinyl alcohol resin “300 parts of 5% aqueous solution of PVA 205 (saponification degree: 88 mol %, polymerization degree: 500, manufactured by Kuraray Co., Ltd.)” in <Composition of coating liquid C for protective layer> in Example 2.

### Comparative Example 4

An antistatic plastic film was obtained in the same manner as in Example 2 except for using a coating liquid G for a protective layer in which an aqueous solution of polyvinyl alcohol resin “300 parts of 5% aqueous solution of PVA 105 (saponification degree: 98.5 mol %, polymerization degree: 500, manufactured by Kuraray Co., Ltd.)” was changed to an aqueous solution of polyvinyl alcohol resin “300 parts of 5% aqueous solution of PVA 405 (saponification degree: 81.5 mol %, polymerization degree: 500, manufactured by Kuraray Co., Ltd.)” in <Composition of coating liquid C for protective layer> in Example 2.

Characteristics of the antistatic plastic films obtained as described above were evaluated by the measuring methods described below.

(1) Solvent Resistance

The surface of the protective layer of the thus obtained antistatic plastic film was rubbed 10 times (10 reciprocations) with gauze impregnated with acetone, and then the surface state was visually observed and evaluated as follows.

<Evaluation Criteria>

AA: No change was observed.

CC: Protective layer was peeled off.

(2) Abrasion Resistance (Dry)

After controlling the moisture of the thus obtained antistatic plastic film at 23° C. and 65% RH for 3 hours, the surface of the protective layer was rubbed with a polishing film (lapping film polisher RE-3, manufactured by 3M Japan) under a load of 67 g/cm², and then the plastic film was set on a slide projector (color CABIN-III, manufactured by Cabin Industries, Co., Ltd.) and projected abrasions were visually observed, and evaluated in the manner described below.

<Evaluation Criteria>

AA: No abrasions were observed.

CC: Abrasions were observed.

(3) Abrasions Resistance (Wet)

The thus obtained antistatic plastic film was immersed in distilled water at 25° C. for 1 min. It was taken out after 1 min, and droplets on the surface of the film were wiped off sufficiently with a paper wiper (Kim Wipe S-200, manufactured by Crecia Co., Ltd.).

Just after wiping off the droplets, the surface of the protective layer was rubbed with a polishing film (lapping film polisher RE-3, manufactured by 3M Japan) under a load of 67 g/cm², and then it was set on a slide projector (color CABIN-III, manufactured by Cabin Industries, Co. Ltd.), projected abrasions were visually observed, and evaluated in the manner as described below.

<Evaluation Criteria>

AA: No abrasions were observed.

CC: Abrasions were observed.

(4) Blocking Property

Moisture of the thus obtained two antistatic plastic films were controlled under the circumstance at 50° C. and 85% RH for 24 hours, and then they were stacked so that the protective layers were brought into contact with each other. The stacked product was aged under a load of 200 g/cm² in an atmosphere at 50° C. and 85% RH.

After aging, the two films were separated and the state of the protective layers was observed and evaluated in a manner as described below.

<Evaluation Criteria>

AA: No change was observed.

CC: Protective layer was peeled off.

(5) Surface Resistivity

The surface resistivity of the thus obtained antistatic plastic film was measured by using an insulation resistance tester (Model VE-30, manufactured by Kawaguchi Electric Works Co., Ltd.) in an atmosphere at 25° C. and 10% RH.

The results of the evaluations are shown in Table 1 below.

TABLE 1

| | Protective layer | | | | | | | | | | |
|---|---|---|---|---|---|---|---|---|---|---|---|
| | | PVA | | | | | | Abrasion | | | Surface |
| | Coating | Product | Saponification | Polymerization | drying | Drying | Solvent | resistance | | Blocking | resistivity |
| | Liquid | Name | degree (mol %) | degree | temperature (° C.) | time (min) | resistance | Dry | Wet | property | (Ω/□) |
| Example 1 | B | PVA105 | 98.5 | 500 | 175 | 1 | AA | AA | AA | AA | 2 × 10¹⁰ |
| Example 2 | C | PVA105 | 98.5 | 500 | 175 | 1 | AA | AA | AA | AA | 2 × 10¹⁰ |
| Example 3 | D | MP103 | 98.5 | 300 | 175 | 1 | AA | AA | AA | AA | 2 × 10¹⁰ |
| Example 4 | E | PVA110 | 98.5 | 1000 | 175 | 1 | AA | AA | AA | AA | 2 × 10¹⁰ |
| | | MP103 | | | | | | | | | |
| Example 5 | C | PVA105 | 98.5 | 500 | 195 | 1 | AA | AA | AA | AA | 2 × 10¹⁰ |
| Example 6 | C | PVA105 | 98.5 | 500 | 165 | 1 | AA | AA | AA | AA | 2 × 10¹⁰ |
| Comparative | C | PVA105 | 98.5 | 500 | 155 | 1 | AA | AA | CC | CC | 2 × 10¹⁰ |
| Example 1 | | | | | | | | | | | |
| Comparative | C | PVA105 | 98.5 | 500 | 135 | 1 | CC | CC | CC | CC | 2 × 10¹⁰ |
| Example 2 | | | | | | | | | | | |
| Comparative | F | PVA205 | 88.0 | 500 | 175 | 1 | CC | CC | CC | CC | 2 × 10¹⁰ |
| Example 3 | | | | | | | | | | | |
| Comparative | G | PVA405 | 81.5 | 500 | 175 | 1 | CC | CC | CC | CC | 2 × 10¹⁰ |
| Example 4 | | | | | | | | | | | |

As apparent from Table 1, films of Comparative Examples 2 to 4 were bad in all of the test items. Only the film of Comparative Example 1 in which only the drying temperature was as low as 155° C. was good in the solvent resistance and the abrasion resistance (Dry), but it was bad in the abrasion resistance (Wet) and the blocking property. On the other hand, it can be seen that the films of Examples 1 to 6 were good in all of the test items.

Hereinafter, various embodiments of the invention are described.

1. A method of manufacturing a film, the method comprising coating with a liquid containing a polyvinyl alcohol having a saponification degree of 96 mol % or more on at least one surface of a plastic film support, and drying the coated liquid at a temperature of from 165 to 230° C. to form a protective layer. 2. The method according to embodiment 1, comprising forming the protective layer on one surface of the plastic film support, and forming a photosensitive silver halide photographic emulsion layer on the other surface of the plastic film support.

3. The method according to embodiment 1, wherein the drying is conducted at a temperature of from 170 to 200° C.

4. The method according to embodiment 1, wherein the drying is conducted at a temperature of from 175 to 195° C.

5. The method according to embodiment 1, wherein the thickness of the protective layer is from 0.01 to 10 μm.

6. The method according to embodiment 1, further comprising forming an antistatic layer between the plastic film support and the protective layer.

7. The method according to embodiment 6, wherein the antistatic layer contains a conductive metal oxide.

8. The method according to embodiment 1, wherein the polyvinyl alcohol is represented by the following formula (I). 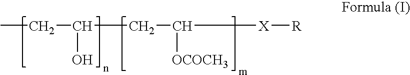
wherein R represents a saturated or unsaturated hydrocarbon group having 5 to 30 carbon atoms, X represents S or O, n represents a polymerization degree of vinyl alcohol groups, and m represents a polymerization degree of vinyl acetate groups.

9. The method according to embodiment 8, wherein X is S in the formula (I).

10. The method according to embodiment 8, wherein the polymerization degree (n+m) of the polyvinyl alcohol is from 100 to 10000.

11. The method according to embodiment 1, wherein the plastic film support comprises polyethylene glycol terephthalate (PET).

12. The method according to embodiment 1, wherein the plastic film support is a biaxially stretched polyester film.

13. A film manufactured by using the method according to embodiment 1.

14. The film according to embodiment 13, wherein the surface resistivity of the film is from 10⁶ to 10¹² Ω/□.

As described above, a method of manufacturing a film excellent in solvent resistance, water resistance, abrasion resistance, and blocking property can be provided according to the invention. Further, a film excellent in solvent resistance, water resistance, abrasion resistance, and blocking property can be provided according to the invention.

What is claimed is:

1. A method of manufacturing a film, the method comprising coating with a liquid containing a polyvinyl alcohol having a saponification degree of 96 mol % or more on at least one surface of a plastic film support, and drying the coated liquid at a temperature of from 165 to 230° C. to form a protective layer.

2. The method according to claim 1, comprising forming the protective layer on one surface of the plastic film support, and forming a photosensitive silver halide photographic emulsion layer on the other surface of the plastic film support.

3. The method according to claim 1, wherein the drying is conducted at a temperature of from 170 to 200° C.

4. The method according to claim 1, wherein the drying is conducted at a temperature of from 175 to 195° C.

5. The method according to claim 1, wherein the thickness of the protective layer is from 0.01 to 10 μm.

6. The method according to claim 1, further comprising forming an antistatic layer between the plastic film support and the protective layer.

7. The method according to claim 6, wherein the antistatic layer contains a conductive metal oxide.

8. The method according to claim 1, wherein the polyvinyl alcohol is represented by the following formula (I). 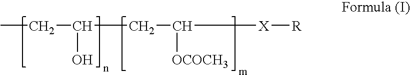
wherein R represents a saturated or unsaturated hydrocarbon group having 5 to 30 carbon atoms, X represents S or O, n represents a polymerization degree of vinyl alcohol groups, and m represents a polymerization degree of vinyl acetate groups.

9. The method according to claim 8, wherein X is S in the formula (I).

10. The method according to claim 8, wherein the polymerization degree (n+m) of the polyvinyl alcohol is from 100 to 10000.

11. The method according to claim 1, wherein the plastic film support comprises polyethylene glycol terephthalate (PET).

12. The method according to claim 1, wherein the plastic film support is a biaxially stretched polyester film.

13. A film manufactured by using the method according to claim 1.

14. The film according to claim 13, wherein the surface resistivity of the film is from 10⁶ to 10¹² Ω/□.
